(19) United States
(12) Patent Application Publication
(10) Pub. No.: US 2026/0071590 A1
(43) Pub. Date: Mar. 12, 2026

(54) VARIABLE FAN NOZZLE THRUST REVERSER ASSEMBLY

(71) Applicant: General Electric Company, Cincinnati, OH (US)

(72) Inventors: Brandon Wayne Miller, Middletown, OH (US); Andrew Hudecki, Milford, OH (US); Daniel Alan Niergarth, Norwood, OH (US)

(21) Appl. No.: 18/800,274

(22) Filed: Aug. 12, 2024

(51) Int. Cl. F02K 1/72; F02K 3/06

(52) U.S. Cl. CPC F02K 1/72; F02K 1/09; F02K 1/763; F05D 2240/14; F05D 2260/50

(57) ABSTRACT

A turbofan engine for an aircraft includes a core cowl, a nacelle assembly positioned radially outward of the core cowl defining a bypass airflow passage between the core cowl and the nacelle assembly where the bypass airflow passage has a fan exit nozzle. The nacelle assembly includes a fan cowl, a transcowl positioned aft of the fan cowl, and a thrust reverser assembly. An actuation assembly is operably connected to at least one of the transcowl or the thrust reverser assembly and is actuatable to move the transcowl aft from a first position where the cascade assembly is covered to a second position where the cascade assembly is uncovered. The actuation assembly is further actuatable to move the transcowl forward from the first position to a third position to reduce an area of the fan exit nozzle.

### FIELD

The present disclosure generally relates to a thrust reverser assembly in a turbofan engine.

### BACKGROUND

Turbofan engines on an aircraft generally include a fan and a turbomachine arranged in flow communication with one another. The turbomachine of the turbofan engine generally includes, in serial flow order, a compression section, a combustion section, a turbine section, and an exhaust section. In operation, a portion of the air provided by the fan flows through the compression section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere. Another portion of the air provided by the fan flows through a bypass airflow passage to create thrust. Thrust reverser systems can be employed in turbofan engines to reduce a landing distance or a load on braking systems of the aircraft. Thrust reverser systems are generally deployed upon landing of the aircraft to redirect the airflow flowing through the bypass airflow passage.

### BRIEF DESCRIPTION OF THE DRAWINGS

The accompanying drawings, which are incorporated in and constitute a part of this specification, illustrate embodiments of the present disclosure and, together with the description, serve to explain principles of the disclosure.

FIG. 1 is a top view of an aircraft according to various exemplary embodiments of the present disclosure;

FIG. 2 is a schematic cross-sectional view of an exemplary turbofan engine according to various embodiments of the present disclosure;

FIG. 3 is a perspective view of an exemplary turbofan engine according to an exemplary embodiment of the present disclosure having a thrust reverser assembly in a deployed configuration;

FIG. 4A is an axial, side, sectional view of the exemplary turbofan engine of FIGS. 2 and 3 depicting the thrust reverser assembly in a position corresponding to a high-power flight phase of the turbofan engine;

FIG. 4B is an axial, side, sectional view of the exemplary turbofan engine of FIGS. 2 and 3 depicting the thrust reverser assembly in a position corresponding to a cruise or low-power flight phase of the turbofan engine;

FIG. 4C is an axial, side, sectional view of the exemplary turbofan engine of FIGS. 2 and 3 depicting the thrust reverser assembly in a deployed position;

FIG. 5A is a sectional view of a portion of the thrust reverser assembly positioned as depicted in FIG. 4A in accordance with the present disclosure;

FIG. 5B is a sectional view of a portion of the thrust reverser assembly positioned as depicted in FIG. 4B in accordance with the present disclosure;

FIG. 5C is a sectional view of a portion of the thrust reverser assembly deployed as depicted in FIG. 4C in accordance with the present disclosure;

FIG. 6 is a flow diagram depicting an embodiment of a method of varying a size of a fan nozzle of a turbofan engine in accordance with various aspects of the present disclosure; and

FIG. 7 is a block diagram depicting an example computing system according to exemplary embodiments of the present disclosure.

Other aspects and advantages of the embodiments disclosed herein will become apparent upon consideration of the following detailed description, wherein similar or identical structures may have similar or identical reference numerals.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components.

The terms “forward” and “aft” refer to relative positions within a turbofan engine, with forward referring to a position closer to an engine inlet and aft referring to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

The term “turbomachine” refers to a machine including one or more compressors, a heat generating section (e.g., a combustion section), and one or more turbines that together generate a torque output.

The term “turbofan engine” refers to an engine having a turbomachine as all or a portion of its power source. Example turbofan engines include gas turbine engines, including turboprop engines, turbojet engines, turboshaft engines, etc., as well as electric or hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The present application is directed generally towards a turbofan engine including a thrust reverser assembly that is actuatable to vary an area of a fan exit nozzle of the turbofan engine. In particular, the present disclosure is directed to a thrust reverser assembly for a turbofan engine having a nacelle assembly with a translating cowl, or transcowl, that is movable during flight phases of the aircraft to vary the area of the fan exit nozzle of the turbofan engine. In exemplary embodiments, the transcowl may be translated forward or aft during a flight phase of the aircraft without being deployed into a bypass airflow passage of the turbofan engine. In other words, during a forward phase of flight of the aircraft, no reverse thrust is generated by the thrust reverser assembly of the present disclosure. The axial translation of the transcowl varies the area of the fan exit nozzle of the turbofan engine. The thrust reverser assembly, and therefore the transcowl, move forward during flight phases and, in particular, during cruise flight phase conditions. The forward movement of the thrust reverser assembly, and therefore the transcowl, reduces the fan nozzle exit area. Embodiments of the present disclosure enabling a lower fan pressure ration (FPR) at cruise flight phase conditions when the thrust reverser assembly remains closed down or undeployed, and enables a higher FPR when more thrust is required to facilitate a lower fan diameter size.

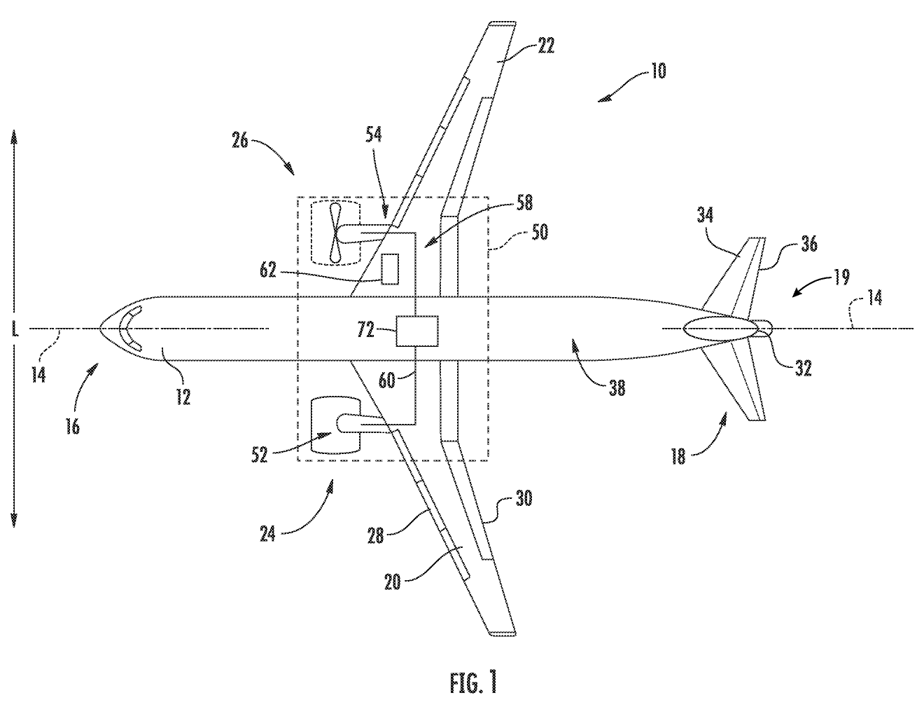

Referring now to the drawings, FIG. 1 provides a top view of an exemplary aircraft 10 as may incorporate various embodiments of the present disclosure. As shown in FIG. 1, the aircraft 10 defines a longitudinal centerline 14 that extends therethrough, a lateral direction L, a forward end 16, and an aft end 18. Moreover, the aircraft 10 includes a fuselage 12, extending longitudinally from the forward end 16 of the aircraft 10 to the aft end 18 of the aircraft 10, and an empennage 19 at the aft end of the aircraft 10. Additionally, the aircraft 10 includes a wing assembly including a side wing 20 and a side wing 22. The side wings 20, 22 each extend laterally outward with respect to the longitudinal centerline 14. The side wing 20 and a portion of the fuselage 12 together define a port side 24 of the aircraft 10, and the side wing 22 and another portion of the fuselage 12 together define a starboard side 26 of the aircraft 10.

Each of the side wings 20, 22 for the exemplary embodiment depicted includes one or more leading edge flaps 28 and one or more trailing edge flaps 30. The aircraft 10 further includes, or rather, the empennage 19 of the aircraft 10 includes, a vertical stabilizer 32 having a rudder flap (not shown) for yaw control, and a pair of horizontal stabilizers 34, each having an elevator flap 36 for pitch control. The fuselage 12 additionally includes an outer surface or skin 38. It should be appreciated however, that in other exemplary embodiments of the present disclosure, the aircraft 10 may additionally or alternatively include any other suitable configuration. For example, in other embodiments, the aircraft 10 may include any other configuration of stabilizer.

The exemplary aircraft 10 of FIG. 1 additionally includes a propulsion system 50 having a propulsor assembly 52 located on the port side 24 of the aircraft 10 and a propulsor assembly 54 located on the starboard side 26 of the aircraft 10. For the embodiment depicted, the propulsor assemblies 52, 54 are each configured in an underwing-mounted configuration. However, one or both of propulsor assemblies 52, 54 may in other exemplary embodiments be mounted at any other suitable location.

The exemplary propulsion system 50 generally includes the propulsor assemblies 52, 54, a controller 72, and a power bus 58. The propulsor assemblies 52, 54 are each electrically connectable through one or more electric lines 60 of the power bus 58. For example, the power bus 58 may include various switches or other power electronics movable to selectively and electrically connect and operate the various components of the propulsion system 50.

The controller 72 is generally configured to control and distribute electrical power between the various components of the propulsion system 50. For example, the controller 72 may be operable with the power bus 58 (including the one or more switches or other power electronics) to provide electrical power to, or draw electrical power from, the various components to operate the propulsion system 50. Such is depicted schematically as the electric lines 60 of the power bus 58 extending through the controller 72. The controller 72 may be a stand-alone controller, dedicated to the propulsion system 50, or alternatively, may be incorporated into one or more of a main system controller for the aircraft 10, a separate controller for a particular propulsor assembly 52 or 54 (such as a full authority digital engine control system, also referred to as a FADEC), etc.

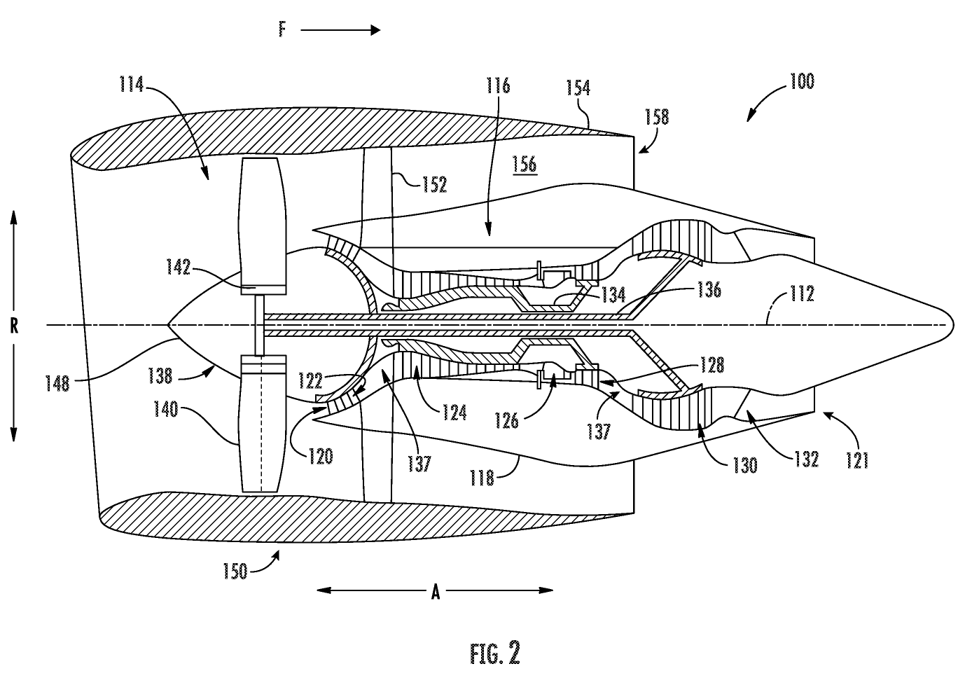

FIG. 2 is a schematic cross-sectional view of a turbofan engine 100 in accordance with an exemplary embodiment of the present disclosure. More particularly, for the embodiment of FIG. 2, the turbofan engine is a high-bypass turbofan jet engine 100. In exemplary embodiments, one or more of the propulsor assemblies 52, 54 (FIG. 1) may be configured as depicted and described in connection with the turbofan engine 100 of FIG. 2. As shown in FIG. 2, the turbofan engine 100 defines an axial direction A (extending parallel to a longitudinal centerline 112 of the turbofan engine 100 provided for reference) and a radial direction R. An airflow direction F is also defined, describing the general directional flow of air through the turbofan engine 100 during normal operation such as takeoff and cruise. The turbofan engine 100 may also define a circumferential direction C extending circumferentially about the axial direction A. In general, the turbofan engine 100 includes a fan section 114 and a turbomachine 116 disposed downstream from the fan section 114.

The exemplary turbomachine 116 depicted is generally enclosed within a substantially tubular core cowl 118 that defines an annular inlet 120 and an annular exhaust 121. The core cowl 118 encases, in serial flow relationship, a compressor section including a booster or low pressure (LP) compressor 122 and a high pressure (HP) compressor 124; a combustion section 126; a turbine section including a high pressure (HP) turbine 128 and a low pressure (LP) turbine 130; and a jet exhaust nozzle section 132. A high pressure (HP) shaft or spool 134 drivingly connects the HP turbine 128 to the HP compressor 124. A low pressure (LP) shaft or spool 136 drivingly connects the LP turbine 130 to the LP compressor 122. The compressor section, combustion section 126, turbine section, and nozzle section 132 together define a core air flowpath 137 therethrough.

For the embodiment depicted, the fan section 114 includes a fixed pitch fan 138 having a plurality of fan blades 140. The fan blades 140 may for example each be attached to a disk 142 with the fan blades 140 and the disk 142 together rotatable about the longitudinal centerline 112 by the LP shaft 136. For the embodiment depicted, the turbofan engine 100 is a direct drive turbofan engine, such that the LP shaft 136 drives the fan 138 of the fan section 114 directly, without use of a reduction gearbox. However, in other exemplary embodiments of the present disclosure, the turbofan engine 100 may include a reduction gearbox, in which case the LP shaft 136 may drive the fan 138 of the fan section 114 across the gearbox.

The disk 142 is covered by a rotatable front hub 148 aerodynamically contoured to promote an airflow through the plurality of fan blades 140. Additionally, the exemplary turbofan engine 100 includes an annular nacelle assembly 150 that circumferentially surrounds the fan 138 and/or at least a portion of the turbomachine 116. For the embodiment depicted, the nacelle assembly 150 is supported relative to the turbomachine 116 by a plurality of circumferentially-spaced outlet guide vanes 152. Moreover, a downstream section 154 of the nacelle assembly 150 extends over an outer portion of the core cowl 118 so as to define an annular bypass airflow passage 156 therebetween. The ratio between a first portion of air through the bypass airflow passage 156 and a second portion of air through the inlet 120 of the turbomachine 116, and through the core air flowpath 137, is commonly known as a bypass ratio. As is depicted, the core cowl 118 of the turbomachine 116 defines a radially inward boundary of the bypass airflow passage 156 and the nacelle assembly 150 defines a radially outward boundary of the bypass airflow passage 156. Bypass air of the turbofan engine 100 passes through the bypass airflow passage 156 and exits through a fan exit nozzle 158 during certain operations.

It should be appreciated, however, that the exemplary turbofan engine 100 depicted in FIG. 2 is by way of example only, and that in other exemplary embodiments, the turbofan engine 100 may have any other suitable configuration, including, for example, any other suitable number of shafts or spools, a pitch change mechanism for the fan 138 (which would no longer be a fixed pitch fan), a reduction gearbox between the LP shaft 136 and the fan 138, etc.

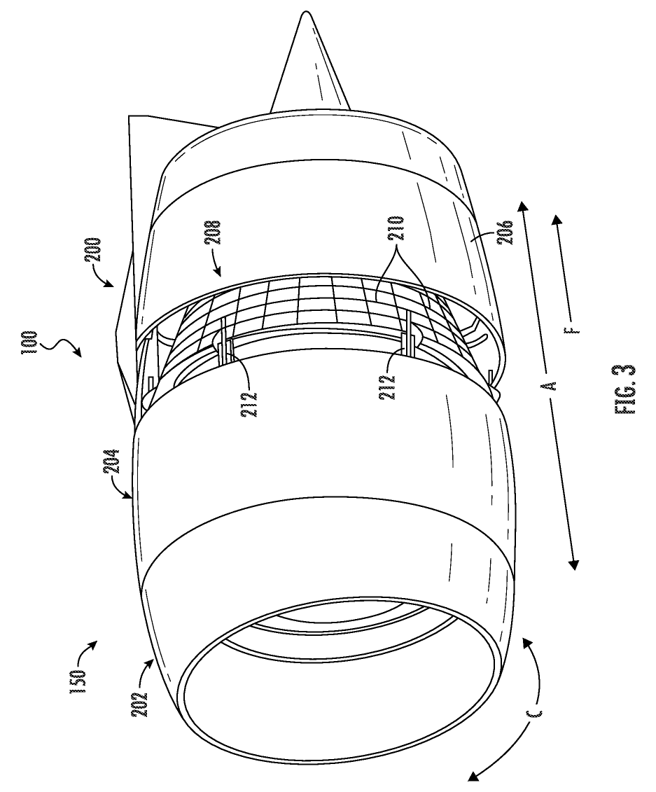

Referring now to FIG. 3, the turbofan engine 100 in accordance with an exemplary embodiment of the present includes a thrust reverser assembly 200 in accordance with an exemplary embodiment of the present disclosure. Specifically, FIG. 3 provides a perspective view of the exemplary turbofan engine 100 with the thrust reverser assembly 200 in a deployed configuration. As depicted, the nacelle assembly 150 of the turbofan engine 100 generally includes an inlet assembly 202, a fan cowl 204, and the thrust reverser assembly 200. The inlet assembly 202 is positioned at a forward end of the nacelle assembly 150 and the fan cowl 204 is positioned aft of the inlet assembly 202 and at least partially surrounds the fan 138 (FIG. 1).

The thrust reverser assembly 200 may include a translating cowl (transcowl) 206 slidably mounted to the fan cowl 204, and a cascade assembly 208. As evident from FIG. 3, the transcowl 206 is the aft-most section of the nacelle assembly 150, located aft of the fan cowl 204 and circumscribing the core cowl 118 (FIG. 2) of the turbomachine 116 (FIG. 2). In exemplary embodiments, the cascade assembly 208 may be provided in an axially-fixed configuration. For example, the cascade assembly 208 may be fixed in the axial direction A with respect to the fan cowl 204. In this example, translating of the transcowl 206 aft in the axial direction A relative to the fan cowl 204 and the cascade assembly 208 can reveal or uncover the cascade assembly 208 in the deployed configuration as shown in FIG. 3. However, it should be understood that the thrust reverser assembly 200 may be otherwise configured such that, by way of non-limiting example, the thrust reverser assembly 200 may be positioned at least partially or substantially completely within the fan cowl 204, at least partially or substantially completely within the transcowl 206, or partially within the fan cowl 204 and partially within the transcowl 206, when in the stowed configuration. In such an exemplary embodiment, when in a deployed configuration, axial movement of the cascade assembly 208 would also position the cascade assembly 208 at least partially aft of the fan cowl 204 and circumscribe the core cowl 118 (FIG. 2) of the turbomachine 116 (FIG. 2). It should be understood that axial movement of the cascade assembly 208 may be employed in various embodiments independent of other movements or transformations of the cascade assembly 208. For example, the cascade assembly 208 may be lowered in the radial direction R without first undergoing any axial movement or sliding within the turbofan engine 100. Furthermore, it should be understood that expansion of the cascade assembly 208 in the radial direction R may also be independently combined with axial sliding and/or radial lowering of the cascade assembly 208.

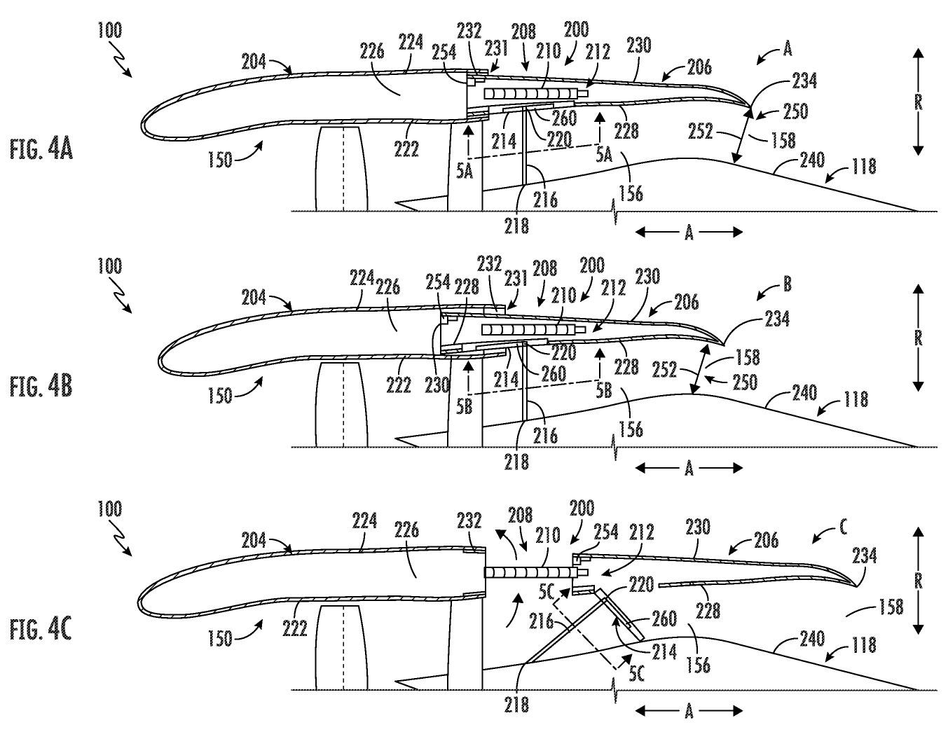

FIGS. 4A-4C depict different positions or actuation states of the thrust reverser assembly 200 according to the present disclosure. In exemplary embodiments, the thrust reverser assembly 200 may be selectively positioned, or translated forward or aft, during different flight phases of the aircraft 10 (FIG. 1) to adjust the area of the fan exit nozzle 158 for such flight phases. In FIG. 4A, the thrust reverser assembly 200 is depicted in a position A corresponding generally to a high-power flight phase such as, by way of non-limiting example, a takeoff flight phase or a top-of-climb flight phase of the aircraft 10 (FIG. 1). In FIG. 4B, the thrust reverser assembly 200 is depicted in a position B corresponding generally to a low-power flight phase such as, by way of non-limiting example, a cruise flight phase of the aircraft 10 (FIG. 1). In FIG. 4C, the thrust reverser assembly 200 is depicted in a position C corresponding to a deployed configuration (i.e., is deployed). In other words, FIG. 4C depicts the thrust reverser assembly 200 in a deployed state, in position C, such that a flow of bypass air within the bypass airflow passage 156 is diverted to provide a thrust reversal effect.

In exemplary embodiments, the cascade assembly 208 includes one or more cascade vanes 210 that are circumferentially spaced around a circumference of the nacelle assembly 150. The cascade vanes 210 are disposed between or at the juncture of the fan cowl 204 and the transcowl 206 which are selectively uncovered upon axial translation of the transcowl 206 upon reaching the position C or become uncovered as the transcowl 206 moves aft from the position A to the position C. In exemplary embodiments of the present disclosure, the cascade vanes 210 remain covered in positions A and B. In exemplary embodiments, one or more actuation assemblies 212 are mounted to the nacelle assembly 150. The actuation assemblies 212 may be circumferentially spaced apart and coupled to at least one of the transcowl 206 or the thrust reverser assembly 200. The actuation assemblies 212 are configured to move or translate the transcowl 206 in an axial direction forward and aft with respect to the fan cowl 204. The actuation assemblies 212 can be of any suitable type such as, by way of non-limiting example, rails, gliding elements, carriages, threaded rods, linkages or link assemblies, ball-screw or screw jack actuators, rotary actuators, etc., and can be driven by, e.g., pneumatic, hydraulic, or electric motors.

The thrust reverser assembly 200 also includes one or more blocker doors 214 pivotally mounted to the transcowl 206 that border the bypass airflow passage 156 when stowed. The blocker doors 214 are selectively deployed when the transcowl 206 is translated aft to the position C as depicted in FIG. 4C. In exemplary embodiments, one or more drag links 216 are operatively coupled to the blocker doors 214 for moving the blocker doors 214 between a stowed position (positions A and B) and a deployed position (position C). In the exemplary embodiments, a radially inward end 218 of the drag link 216 is pivotally coupled to the core cowl 118, and a radially outward end 220 of the drag link 216 is pivotally coupled to an intermediate portion of a respective blocker door 214. The blocker doors 214 are also pivotally coupled to the transcowl 206 at or near a forward or upstream end of the transcowl 206 so that the blocker doors 214 may pivot into the bypass airflow passage 156 (i.e., deployed) as the transcowl 206 translates in the aft direction from the position B to the position C.

Referring to FIGS. 4A and 4B, the fan cowl 204 includes an inner wall 222, and an outer wall 224 disposed radially outward and spaced apart from the inner wall 222. The inner wall 222 and the outer wall 224 define an interior area 226 of the fan cowl. The transcowl 206 also includes an inner wall 228, and an outer wall outer 230 disposed radially outward and spaced apart from the inner wall 228. In exemplary embodiments, in at least one or more of the positions A and B, at least a portion of the transcowl 206 is positioned within the fan cowl 204 or at least partially within the interior area 226 of the fan cowl 204. In other words, in at least one or more of the positions A and B, at least a portion of the outer wall 224 of the fan cowl 204 is disposed radially outward from and overlaps at least a portion of the outer wall 230 of the transcowl 206, and at least a portion of the inner wall 222 of the fan cowl 204 is disposed radially inward from and overlaps at least a portion of the inner wall 228 of the transcowl 206. In the illustrated embodiment, the overlapped position of the outer wall 224 with respect to the outer wall 230 causes an aft-facing step 231 at the radially outward interface of the fan cowl 204 with the transcowl 206, and the overlapped position of the inner wall 222 with respect to the inner wall 228 causes an aft-facing step 233 at the radially inward interface of the fan cowl 204 with the transcowl 206 within the bypass airflow passage 156. In exemplary embodiments, in at least one or more of the positions A and B, at least a portion of the transcowl 206 is positioned within the fan cowl 204 or at least partially within the interior area 226 of the fan cowl 204 such that the steps 231 and 233 are aft-facing to avoid airflow separation in at least the bypass airflow passage 156. In exemplary embodiments, one or more seals 232 may be disposed between the fan cowl 204 and the transcowl 206 in the overlapping portion or at another suitable interface of the fan cowl 204 and the transcowl 206 to seal against undesirable airflow leakage radially outwardly from the bypass airflow passage 156 such as, by way of non-limiting example, when the transcowl 206 is located in at least one or more of the positions A and B. The seal 232 may be any conventional seal or sealing mechanism such as, by way of non-limiting example, a compressible sealing material, seals as used in bleed air applications, seals as used in ducting applications, or various types of thrust reverser door seals.

As described above, the bypass airflow passage 156 is configured to provide a converging flow area which terminates near a trailing edge 234 of the transcowl 206 corresponding to the fan exit nozzle 158. As depicted in FIGS. 4A-4C, the core cowl 118 has a contoured portion 240 that slopes radially inward as the core cowl 118 extends aft in the axial direction such that the core cowl 118 and the transcowl 206 define the fan exit nozzle 158. As depicted in FIGS. 4A and 4B, axial translation of the transcowl 206 between the positions A and B, respectively, varies a throat area 250 of the fan exit nozzle 158. The throat area 250 may be defined as a minimum flow area defined by the fan exit nozzle 158 measured along a line 252 extending perpendicular to and radially outward from contoured portion 240 of the core cowl 118. Thus, axial movement or translation of the transcowl 206 also causes the axial movement or translation of the trailing edge 234 of the transcowl 206 with respect to the core cowl 118 and the contoured portion 240. Accordingly, the variable positioning of the trailing edge 234 of the transcowl 206 with respect to the contoured portion 240 causes a change in a length of the line 252 and, correspondingly, a size of the throat area 250. In exemplary embodiments, for the turbofan engine 100 depicted in FIGS. 4A and 4B configured as a short duct separate flow exhaust system, the throat area 250 at the position A (FIG. 4A) is greater than the throat area 250 at the position B (FIG. 4B).

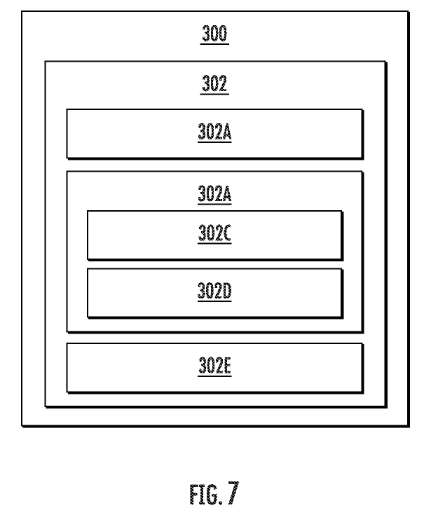

In exemplary embodiments, a sensor 254 may be used to sense or detect the axial position of the transcowl 206. The sensor 254 may be communicatively coupled to the controller 72 (FIG. 1). The actuation assembly 212 may be automatically controlled, such as by the controller 72 (FIG. 1), based on information communicated by the sensor 254. Thus, the controller 72 (FIG. 1) may be used to vary the throat area 250 of the fan exit nozzle 158 based on the sensed or detected position of the transcowl 206. The controller 72 may be configured similar to exemplary computing devices of the computing system 300 described below with reference to FIG. 7.

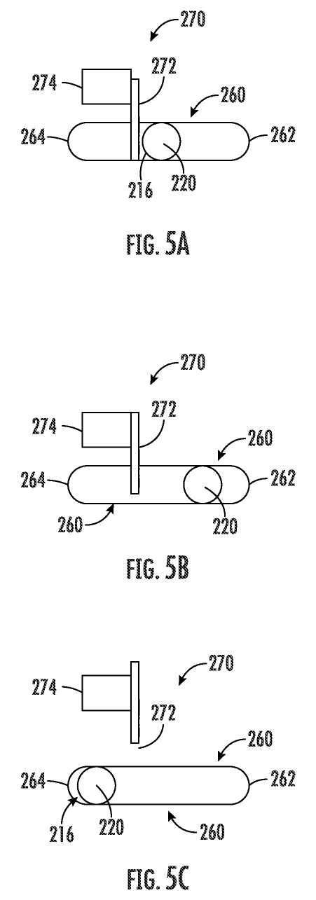

In exemplary embodiments, the ends 220 of the drag links 216 are pivotally coupled to the respective blocker doors 214 via one or more slot joints 260. The one or more slot joints 260 extend axially (when the blocker doors 214 are in a stowed position, such as in positions A and B) such that the transcowl 206 is movable forward and aft without deploying the blocker doors 214. In other words, the ends 220 of the drag links 216 are axially movable within the slot joints 260 resulting from axial movement of the transcowl 206. FIGS. 5A-5C depict the position of the end 220 of the drag link 216 within the slot joint 260 corresponding to respective positions A-C of respective FIGS. 4A-4C. As depicted in FIG. 5A, in the position A, the end 220 of the drag link 216 is medially positioned within the slot joint 260. In FIG. 5B, the transcowl 206 has been translated axially forward (FIG. 4B) such that the end 220 of the drag link 216 is positioned at or near an aft end 262 of the slot joint 260. In FIG. 5C, the transcowl 206 has been translated axially aft (FIG. 4C) such that the end 220 of the drag link 216 has reached a forward end 264 of the slot joint 260 such that the end 220 is prevented or restrained from further axial movement within the slot joint 260. Accordingly, when the end 220 reaches forward end 264 of the slot joint 260, further axial rearward movement of the transcowl 206 causes the blocker doors 214 (FIG. 4C) to be pivoted radially inward into a deployed position as depicted in the position C (FIG. 4C).

In exemplary embodiments, one or more stop mechanisms 270 may be included and configured to prevent movement of the transcowl 206 to the position C in flight (FIGS. 4C and 5C) without sensing the aircraft 10 (FIG. 1) has landed by use of a sensor such as, by way of non-limiting example, a weight on wheels indication or, in other words, to prevent deployment of the blocker doors 214 (FIGS. 4A-4C) in a flight phase of the aircraft 10 (FIG. 1). In exemplary embodiments, the one or more stop mechanisms 270 may include a hydraulically or electromechanically actuatable mechanism that limits aft movement of the transcowl 206 (FIGS. 4A-4C) until a weight on wheels sensor (not shown) is engaged due to the aircraft 10 (FIG. 1) being on the ground. In exemplary embodiments, the one or more stop mechanisms 270 may include a pin, track stop, motor limit stop, or other type of mechanism configured to limit aft movement of the transcowl 206.

In FIGS. 5A-5C, the one or more stop mechanisms 270 include one or more pins 272 coupled to or movably positionable with respect to the one or more slot joints 260. The one or more pins 272 may be coupled to one or more actuators 274 that are actuatable to cause movement of the one or more pins 272 with respect to the one or more respective slot joints 260. The one or more actuators 274 may be part of the actuation assembly 212 or may be independent or stand-alone actuators. In exemplary embodiments, at least a portion of the one or more pins 272 may reside within at least a portion of the slot joint 260, such as depicted in FIGS. 5A and 5B, to prevent axial travel of the end 220 of the drag link 216 to the forward end 264 of the slot joint 260. In FIGS. 5A and 5B, the pin 272 may be considered in an actuated position such that the pin 272 prevents axial travel of the end 220 of the drag link 216 to the forward end 264 of the slot joint 260. In response to a weight on wheel indication, the actuators 274 may be actuated to move or withdraw the one or more pins 272 from the slot joint 260, as depicted in FIG. 5C, to enable movement of the end 220 of the drag link 216 to the forward end 264 of the slot joint 260 to deploy the blocker doors 214 (FIGS. 4A-4C).

Thus, in FIG. 5C, the pin 272 is in a de-actuated position with respect to the slot joint 260. Accordingly, the one or more stop mechanisms 270 may be actuated or de-actuated to respectively prevent or enable axial translation of the transcowl 206 into the deploy position of the thrust reverser assembly 200 as depicted in position C (FIG. 4C). It should be understood that the one or more stop mechanisms 270 may also be part of or formed as part of the actuation assembly 212 (FIGS. 4A-4C) such that the actuation assembly 212 (FIGS. 4A-4C) is configured to limit axial aft travel of the transcowl 206 to the position C to deploy the blocker doors 214 (FIGS. 4A-4C) without a weight on wheel indication. The actuation assembly 212 (FIGS. 4A-4C), the actuator 274 (FIGS. 5A-5B), or both, may be automatically controlled, such as by the controller 72 (FIG. 1). It should also be understood that other types of mechanisms or linkage assemblies may be used to enable in-flight forward and aft movement of the transcowl 206 (FIGS. 4A-4C) such as, by way of non-limiting example, a slider mechanism on the drag links 216 (FIGS. 4A-4C) to effectively create a slider crank mechanism.

In exemplary embodiments, the controller 72 (FIG. 1) may be configured to control the throat area 250 of the fan exit nozzle 158 (FIGS. 4A and 4B) via the actuation assembly 212 (FIGS. 4A-4C) to correspondingly control a maximum or minimum fan pressure ratio (FPR) variation as a function of an operating condition of the turbofan engine 100 (FIG. 2). The FPR is a ratio between a first volume of air passing through the bypass airflow passage 156 (FIG. 2) and a second volume of air passing through the core air flowpath 137 (FIG. 2). By controlling the axial movement of the transcowl 206 (FIGS. 4A and 4B) between the respective positions A and B (FIGS. 4A and 4B) and, correspondingly, the throat area 250 of the fan exit nozzle 158 (FIGS. 4A and 4B), variations in the FPR can be controlled during different flight phases of the aircraft 10 (FIG. 1). In exemplary embodiments, the controller 72 (FIG. 1) may be configured to control the throat area 250 of the fan exit nozzle 158 (FIGS. 4A and 4B) via the actuation assembly 212 (FIGS. 4A-4C) based on a percentage of a maximum thrust of the turbofan engine 100 (FIG. 2). For example, in exemplary embodiments, a ratio of the percentage of maximum thrust of the turbofan engine 100 (FIG. 2) with respect to the rotational speed of the LP spool 136 (FIG. 2) may be used to define or control the throat area 250 of the fan exit nozzle 158 (FIGS. 4A and 4B) via the actuation assembly 212 (FIGS. 4A-4C). It should also be understood that the controller 72 (FIG. 1) may be configured to automatically control the throat area 250 of the fan exit nozzle 158 (FIGS. 4A and 4B) via the actuation assembly 212 (FIGS. 4A-4C) based on other detected parameters of the turbofan engine 100 (FIG. 2), based on different flight phases of the aircraft 10 (FIG. 1), and/or based on user instructions, such as from a pilot of the aircraft 10 (FIG. 1).

In exemplary embodiments, in response to detecting a failure indication corresponding to the thrust reverser assembly 200 (FIGS. 4A-4C), the actuation assembly 212 is configured to move the transcowl 206 to the position A depicted in FIG. 4A. For example, in exemplary embodiments, in response to detecting a failure indication corresponding to the thrust reverser assembly 200 (FIGS. 4A-4C), the controller 72 (FIG. 1) may actuate the actuation assembly 212 to translate the transcowl 206 to the position A depicted in FIG. 4A to obtain a largest possible throat area 250 of the fan exit nozzle 158 as depicted in FIG. 4A.

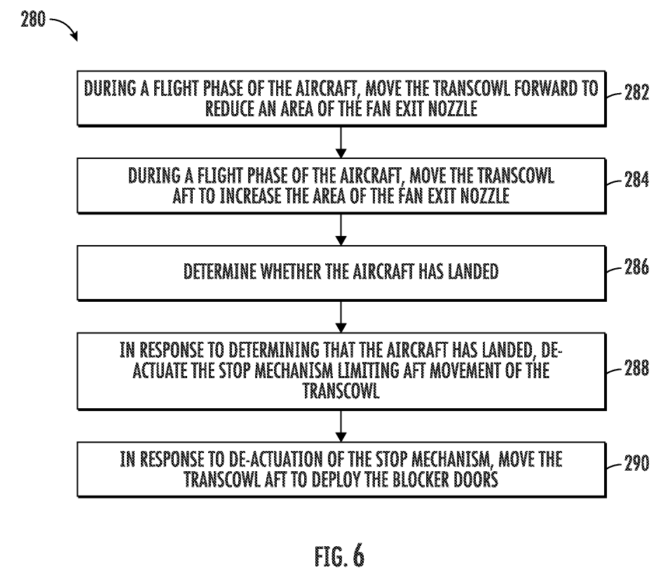

FIG. 6 provides a flow diagram of an exemplary method (280) for varying a size of the throat area 250 of the fan exit nozzle 158 in accordance with exemplary embodiments of the present disclosure. It should be appreciated that the method (280) is discussed herein only to describe exemplary aspects of the present subject matter and is not intended to be limiting.

At (282), the method (280) includes, during a flight phase of the aircraft 10, moving the transcowl 206 forward to reduce an area of the fan exit nozzle 158. As described above, movement of the transcowl 206 forward may be automatically controlled such as, by way of non-limiting example, by the controller 72 based on a percentage of a maximum thrust of the turbofan engine 100, based on a particular phase of a flight condition of the aircraft 10, or by pilot control. At (284), the method (280) includes, during a flight phase of the aircraft 10, moving the transcowl 206 aft to increase an area of the fan exit nozzle 158. Similarly, movement of the transcowl 206 aft may be automatically controlled such as, by way of non-limiting example, by the controller 72 based on a percentage of a maximum thrust of the turbofan engine 100, based on a particular phase of a flight condition of the aircraft 10, or by pilot control. At (286), the method (280) includes determining whether the aircraft 10 has landed such as, by way of non-limiting example, detecting a weight on wheels indication, such as by the controller 72. At (288), the method (280) includes, responsive to detecting that the aircraft 10 has landed, de-actuating the stop mechanism 270 restricting or limiting aft travel of the transcowl 206. De-actuation of the stop mechanism 270 may also be automatically controlled such as, by way of non-limiting example, by the controller 72 in response to detecting that the aircraft 10 has landed. At (290), the method (280) includes, responsive to de-actuating the stop mechanism 270, moving the transcowl 206 aft to deploy the blocker doors 214. The aft movement of the transcowl 206 to deploy the blocker doors 214 may also be automatically controlled, such as by the controller 72.

FIG. 7 provides an example computing system 300 according to example embodiments of the present disclosure. The computing devices or elements described herein, such as the controller 72 (FIG. 1), may include various components and perform various functions of the computing system 300 described below, for example.

As shown in FIG. 7, the computing system 300 can include one or more computing device(s) 302. The computing device(s) 302 can include one or more processor(s) 302A and one or more memory device(s) 302B. The one or more processor(s) 302A can include any suitable processing device, such as a microprocessor, microcontroller, integrated circuit, logic device, and/or other suitable processing device. The one or more memory device(s) 302B can include one or more computer-executable or computer-readable media, including, but not limited to, non-transitory computer-readable media, RAM, ROM, hard drives, flash drives, and/or other memory devices.

The one or more memory device(s) 302B can store information accessible by the one or more processor(s) 302A, including computer-readable instructions 302C that can be executed by the one or more processor(s) 302A. The computer-readable instructions 302C can be any set of instructions that when executed by the one or more processor(s) 302A, cause the one or more processor(s) 302A to perform operations. In some embodiments, the computer-readable instructions 302C can be executed by the one or more processor(s) 302A to cause the one or more processor(s) 302A to perform operations, such as any of the operations and functions for which the computing system 300 and/or the computing device(s) 302 are configured, such as controlling operation of actuation assembly 212, the actuators 274, or both. The computer-readable instructions 302C can be software written in any suitable programming language or can be implemented in hardware. Additionally, and/or alternatively, the computer-readable instructions 302C can be executed in logically and/or virtually separate threads on processor(s) 302A. The memory device(s) 302B can further store data 302D that can be accessed by the processor(s) 302A. For example, the data 302D can include models, lookup tables, databases, etc.

The computing device(s) 302 can also include a network interface 302E used to communicate, for example, with the other components of the computing system 300 (e.g., via a communication network). The network interface 302E can include any suitable components for interfacing with one or more network(s), including for example, transmitters, receivers, ports, controllers, antennas, and/or other suitable components. One or more devices can be configured to receive one or more commands from the computing device(s) 302 or provide one or more commands to the computing device(s) 302.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Thus, embodiments of the present disclosure provide a thrust reverser assembly that is actuable to vary an area of a fan exit nozzle of the turbofan engine during a flight phase of an aircraft. In particular, the transcowl of a turbofan engine is movable forward and aft during flight phases of the aircraft to vary the area of the fan exit nozzle of a turbofan engine. In exemplary embodiments, the transcowl may be translated forward or aft during a flight phase of the aircraft without being deployed, or without deploying blocker doors into the bypass airflow passage of the turbofan engine. In other words, during a forward phase of flight of the aircraft, no reverse thrust is generated by the thrust reverser assembly of the present disclosure. The forward movement of the thrust reverser assembly, and therefore the transcowl, reduces the fan nozzle exit area. Embodiments of the present disclosure enables a lower fan pressure ration (FPR) at cruise flight phase conditions when the thrust reverser assembly remains closed down or undeployed, and enables a higher FPR when more thrust is required to facilitate a lower fan diameter size. Embodiments of the present disclosure also include one or more stop mechanisms to restrict aft movement of the transcowl to a thrust reverser deployed state during a flight phase of the aircraft.

Further aspects are provided by the subject matter of the following clauses:

A turbofan engine for an aircraft, the turbofan engine comprising: a core cowl; a nacelle assembly positioned radially outward of the core cowl defining a bypass airflow passage between the core cowl and the nacelle assembly, the bypass airflow passage having a fan exit nozzle, the nacelle assembly comprising: a fan cowl; a transcowl positioned aft of the fan cowl; and a thrust reverser assembly having a cascade assembly; and an actuation assembly operably connected to at least one of the transcowl or the thrust reverser assembly, wherein the actuation assembly is actuatable to move the transcowl aft from a first position where the cascade assembly is covered to a second position where the cascade assembly is uncovered, the actuation assembly further actuatable to move the transcowl forward from the first position to a third position to reduce an area of the fan exit nozzle.

The turbofan engine of the preceding clause, wherein at least a portion of the transcowl is positioned within the fan cowl when the transcowl is in the third position.

The turbofan engine of any preceding clause, wherein the thrust reverser assembly comprises: one or more blocker doors deployable into the bypass airflow passage when the transcowl is moved from the first position to the second position; and one or more drag links pivotally coupled to the one or more blocker doors via one or more slot joints.

The turbofan engine of any preceding clause, further comprising at least one stop mechanism configured to prevent movement of the transcowl to the second position without a weight on wheels indication.

The turbofan engine of any preceding clause, wherein the at least one stop mechanism is coupled to the actuation assembly.

The turbofan engine of any preceding clause, wherein the thrust reverser assembly comprises: one or more blocker doors deployable into the bypass airflow passage when the transcowl is moved from the first position to the second position; and one or more drag links pivotally coupled to the one or more blocker doors via one or more slot joints; and wherein the at least one stop mechanism is coupled to the one or more slot joints.

The turbofan engine of any preceding clause, wherein the cascade assembly is covered when the transcowl is in the third position.

The turbofan engine of any preceding clause, wherein the actuation assembly is actuatable to move the transcowl aft from the third position to the first position during at least one of a top of climb flight phase or a cruise flight phase of the aircraft.

The turbofan engine of any preceding clause, wherein the actuation assembly is actuatable to move the transcowl forward from the first position to the third position during at least one of a top of climb flight phase or a cruise flight phase of the aircraft.

The turbofan engine of any preceding clause, wherein, in response to detecting a failure indication corresponding to the thrust reverser assembly, the actuation assembly is configured to move the transcowl from the third position to the first position.

The turbofan engine of any preceding clause, further comprising a controller configured to automatically control the actuation assembly.

The turbofan engine of any preceding clause, wherein the at least one stop mechanism includes at least one pin movably positionable with respect to the slot joint.

The turbofan engine of any preceding clause, wherein at least a portion of the fan cowl overlaps at least a portion of the transcowl in at least one of the first position or the third position.

The turbofan engine of any preceding clause, wherein a position of the fan cowl with respect to the transcowl in at least one of the first position or the third position forms at least one aft facing step at an interface of the fan cowl with the transcowl.

The turbofan engine of any preceding clause, wherein the at least one aft facing step is located at one or more of a radially inward interface of the fan cowl with the transcowl or a radially outward interface of the fan cowl with the transcowl.

The turbofan engine of any preceding clause, wherein the radially inward interface is within the bypass airflow passage.

The turbofan engine of any preceding clause, further comprising one or more seals disposed at an interface of the fan cowl with the transcowl.

The turbofan engine of any preceding clause, wherein at least one seal of the one or more seals is disposed between an overlapping portion of the fan cowl with respect to the transcowl.

A turbofan engine for an aircraft, the turbofan engine comprising: a core cowl; a nacelle assembly positioned radially outward of the core cowl defining a bypass airflow passage between the core cowl and the nacelle assembly, the nacelle assembly comprising: a fan cowl; a transcowl positioned aft of the fan cowl; and a thrust reverser assembly deployable into the bypass airflow passage in response to aft movement of the transcowl with respect to the fan cowl; and an actuation assembly operably connected to the transcowl, wherein the actuation assembly is actuatable to move the transcowl forward during a cruise flight phase of the aircraft.

The turbofan engine of any preceding clause, wherein the bypass airflow passage has a fan exit nozzle defined between the core cowl and the nacelle assembly, and wherein the actuation assembly is actuatable to move the transcowl forward during the cruise flight phase to reduce an area of the fan exit nozzle.

The turbofan engine of any preceding clause, wherein the thrust reverser assembly includes a cascade assembly, and wherein the cascade assembly is covered when the transcowl is moved forward during the cruise flight phase.

The turbofan engine of any preceding clause, wherein at least a portion of the transcowl is positioned within the fan cowl when the transcowl is moved forward.

The turbofan engine of any preceding clause, wherein the thrust reverser assembly comprises: one or more blocker doors deployable into the bypass airflow passage; and one or more drag links pivotally coupled to the one or more blocker doors via one or more slot joints.

The turbofan engine of any preceding clause, further comprising at least one stop mechanism configured to prevent movement of the transcowl aft to deploy the thrust reverser assembly without a weight on wheels indication.

A method for operating a turbofan engine for an aircraft, the turbofan engine including a core cowl and a nacelle assembly positioned radially outward of the core cowl defining a bypass airflow passage having a fan exit nozzle between the core cowl and the nacelle assembly, wherein the nacelle assembly includes a fan cowl, a transcowl, and a thrust reverser assembly deployable into the bypass airflow passage in response to aft movement of the transcowl, the method comprising: operating the turbofan engine in a cruise flight phase of the aircraft; and while the aircraft is in the cruise flight phase, moving, via a controller, the transcowl forward to reduce an area of the fan exit nozzle.

The method of any preceding clause, wherein moving the transcowl forward comprises positioning at least a portion of the transcowl within the fan cowl.

The method of any preceding clause, further comprising at least one stop mechanism configured to prevent movement of the transcowl to deploy the thrust reverser assembly while the aircraft is in the cruise flight phase, the method further comprising: de-actuating, via the controller, the stop mechanism in response to detecting a weight on wheels indication.

The method of any preceding clause, wherein the thrust reverser assembly comprises: one or more blocker doors deployable into the bypass airflow passage; and one or more drag links pivotally coupled to the one or more blocker doors via one or more slot joints; and wherein moving the transcowl forward comprises moving the transcowl along the one or more slot joints

This written description uses examples to disclose the preferred embodiments, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

We claim:

1. A turbofan engine for an aircraft, the turbofan engine comprising:
a core cowl;
a nacelle assembly positioned radially outward of the core cowl defining a bypass airflow passage between the core cowl and the nacelle assembly, the bypass airflow passage having a fan exit nozzle, the nacelle assembly comprising:
a fan cowl;
a transcowl positioned aft of the fan cowl; and
a thrust reverser assembly having a cascade assembly; and
an actuation assembly operably connected to at least one of the transcowl or the thrust reverser assembly, wherein the actuation assembly is actuatable to move the transcowl aft from a first position where the cascade assembly is covered to a second position where the cascade assembly is uncovered, the actuation assembly further actuatable to move the transcowl forward from the first position to a third position to reduce an area of the fan exit nozzle.

2. The turbofan engine of claim 1, wherein at least a portion of the transcowl is positioned within the fan cowl when the transcowl is in the third position.

3. The turbofan engine of claim 1, wherein the thrust reverser assembly comprises:
one or more blocker doors deployable into the bypass airflow passage when the transcowl is moved from the first position to the second position; and
one or more drag links pivotally coupled to the one or more blocker doors via one or more slot joints.

4. The turbofan engine of claim 1, further comprising at least one stop mechanism configured to prevent movement of the transcowl to the second position without a weight on wheels indication.

5. The turbofan engine of claim 4, wherein the at least one stop mechanism is coupled to the actuation assembly.

6. The turbofan engine of claim 4, wherein the thrust reverser assembly comprises:
one or more blocker doors deployable into the bypass airflow passage when the transcowl is moved from the first position to the second position; and
one or more drag links pivotally coupled to the one or more blocker doors via one or more slot joints; and
wherein the at least one stop mechanism is coupled to the one or more slot joints.

7. The turbofan engine of claim 1, wherein the cascade assembly is covered when the transcowl is in the third position.

8. The turbofan engine of claim 1, wherein the actuation assembly is actuatable to move the transcowl aft from the third position to the first position during a cruise flight phase of the aircraft.

9. The turbofan engine of claim 1, wherein the actuation assembly is actuatable to move the transcowl forward from the first position to the third position during a cruise flight phase of the aircraft.

10. The turbofan engine of claim 1, wherein, in response to detecting a failure indication corresponding to the thrust reverser assembly, the actuation assembly is configured to move the transcowl from the third position to the first position.

11. A turbofan engine for an aircraft, the turbofan engine comprising:
a core cowl;
a nacelle assembly positioned radially outward of the core cowl defining a bypass airflow passage between the core cowl and the nacelle assembly, the nacelle assembly comprising:
a fan cowl;
a transcowl positioned aft of the fan cowl; and
a thrust reverser assembly deployable into the bypass airflow passage in response to aft movement of the transcowl with respect to the fan cowl; and
an actuation assembly operably connected to the transcowl, wherein the actuation assembly is actuatable to move the transcowl forward during a cruise flight phase of the aircraft.

12. The turbofan engine of claim 11, wherein the bypass airflow passage has a fan exit nozzle defined between the core cowl and the nacelle assembly, and wherein the actuation assembly is actuatable to move the transcowl forward during the cruise flight phase to reduce an area of the fan exit nozzle.

13. The turbofan engine of claim 12, wherein the thrust reverser assembly includes a cascade assembly, and wherein the cascade assembly is covered when the transcowl is moved forward during the cruise flight phase.

14. The turbofan engine of claim 11, wherein at least a portion of the transcowl is positioned within the fan cowl when the transcowl is moved forward.

15. The turbofan engine of claim 11, wherein the thrust reverser assembly comprises:
one or more blocker doors deployable into the bypass airflow passage; and
one or more drag links pivotally coupled to the one or more blocker doors via one or more slot joints .

16. The turbofan engine of claim 11, further comprising at least one stop mechanism configured to prevent movement of the transcowl aft to deploy the thrust reverser assembly without a weight on wheels indication.

17. A method for operating a turbofan engine for an aircraft, the turbofan engine including a core cowl and a nacelle assembly positioned radially outward of the core cowl defining a bypass airflow passage having a fan exit nozzle between the core cowl and the nacelle assembly, wherein the nacelle assembly includes a fan cowl, a transcowl, and a thrust reverser assembly deployable into the bypass airflow passage in response to aft movement of the transcowl, the method comprising:
operating the turbofan engine in a cruise flight phase of the aircraft; and
while the aircraft is in the cruise flight phase, moving, via a controller, the transcowl forward to reduce an area of the fan exit nozzle.

18. The method of claim 17, wherein moving the transcowl forward comprises positioning at least a portion of the transcowl within the fan cowl.

19. The method of claim 17, further comprising at least one stop mechanism configured to prevent movement of the transcowl to deploy the thrust reverser assembly while the aircraft is in the cruise flight phase, the method further comprising:
de-actuating, via the controller, the stop mechanism in response to detecting a weight on wheels indication.

20. The method of claim 17, wherein the thrust reverser assembly comprises:
one or more blocker doors deployable into the bypass airflow passage; and
one or more drag links pivotally coupled to the one or more blocker doors via one or more slot joints; and
wherein moving the transcowl forward comprises moving the transcowl along the one or more slot joints.
